(19) United States
(12) Patent Application Publication
(10) Pub. No.: US 2024/0429590 A1
(43) Pub. Date: Dec. 26, 2024

(54) ANTENNAS, RELATED DEVICES AND METHODS

(71) Applicant: SKYWORKS SOLUTIONS, INC., Irvine, CA (US)

(72) Inventor: Abdulhadi Ebrahim ABDULHADI, Kanata (CA)

(21) Appl. No.: 18/596,910

(22) Filed: Mar. 6, 2024

Related U.S. Application Data
(60) Provisional application No. 63/450,089, filed on Mar. 6, 2023.

(51) Int. Cl. H01Q 1/22; H01Q 9/04

(52) U.S. Cl. CPC H01Q 1/22; H01Q 9/0407

(57) ABSTRACT

In some embodiments, an antenna device can include a substrate, a ground plane, and first and second antenna elements each having a shape selected from an F-shape and a P-shape. Each antenna element can include a feed point connectable to an antenna circuit and a grounding point electrically connected to the ground plane.

### CROSS-REFERENCE TO RELATED APPLICATION(S)

This application claims priority to U.S. Provisional Application No. 63/450,089 filed Mar. 6, 2023, entitled ANTENNAS, RELATED DEVICES AND METHODS, the disclosure of which is hereby expressly incorporated by reference herein in its entirety.

### BACKGROUND

### Field

The present disclosure relates to antennas, related devices and methods for wireless applications.

### Description of the Related Art

In wireless applications, antennas are implemented to provide transmit and/or receive functionalities. Such antennas can be configured for specific frequency range(s).

### SUMMARY

In accordance with some implementations, the present disclosure relates to an antenna that includes a substrate and a ground plane. The antenna further includes first and second antenna elements each having a shape selected from an F-shape and a P-shape. Each antenna element includes a feed point connectable to an antenna circuit and a grounding point electrically connected to the ground plane.

In some embodiments, each of the F-shape and the P-shape can include a segment having a base end when the respective shape is oriented upright.

In some embodiments, the first antenna element can have the F-shape and the second antenna element can have the P-shape. In some embodiments, the first antenna element can have the F-shape and the second antenna element can have the F-shape. In some embodiments, the first antenna element can have the P-shape and the second antenna element can have the P-shape.

In some embodiments, the ground plane can have a base portion having a first width, and an extension portion having a second width smaller than the first width.

In some embodiments, the base end of each antenna element can be positioned towards the base portion of the ground plane. In some embodiments, the base end of each antenna element can be positioned away from the base portion of the ground plane. In some embodiments, the base end of one antenna element can be positioned towards the base portion of the ground plane, and the base end of the other antenna element can be positioned away from the base portion of the ground plane.

In some embodiments, the substrate can include a circuit board. In some embodiments, the ground plane can be implemented on one side of the circuit board and the first and second antenna elements can be implemented on the other side of the circuit board.

In some embodiments, the circuit board can be dimensioned to fit within an adapter device. In some embodiments, the adapter device can be implemented as a dongle device.

In some embodiments, each of the first and second antenna elements can include a patterned conductor. The patterned conductor can include, for example, a printed pattern formed from a conductive material.

In some implementations, the present disclosure relates to a dongle that includes a housing and a circuit board dimensioned to fit within the housing. The dongle further includes an antenna assembly implemented relative to the circuit board. The antenna assembly includes a ground plane, and first and second antenna elements each having a shape selected from an F-shape and a P-shape. Each antenna element includes a feed point connectable to an antenna circuit and a grounding point electrically connected to the ground plane.

In some embodiments, each of the F-shape and the P-shape can include a segment having a base end when the respective shape is oriented upright.

In some embodiments, the first antenna element can have the F-shape and the second antenna element can have the P-shape. In some embodiments, the first antenna element can have the F-shape and the second antenna element can have the F-shape. In some embodiments, the first antenna element can have the P-shape and the second antenna element can have the P-shape.

In some embodiments, the ground plane can have a base portion having a first width, and an extension portion having a second width smaller than the first width.

In some embodiments, the base end of each antenna element can be positioned towards the base portion of the ground plane. In some embodiments, the base end of each antenna element can be positioned away from the base portion of the ground plane. In some embodiments, the base end of one antenna element can be positioned towards the base portion of the ground plane, and the base end of the other antenna element can be positioned away from the base portion of the ground plane.

In some implementations, the present disclosure relates to a wireless device that includes a radio-frequency circuit and an antenna coupled to the radio-frequency circuit and configured to support a transmit operation and/or a receive operation. The antenna is implemented on a substrate and includes a ground plane and first and second antenna elements each having a shape selected from an F-shape and a P-shape. Each antenna element includes a feed point selectively connectable to the radio-frequency circuit and a grounding point electrically connected to the ground plane.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows a side view of an antenna having one or more features as described herein.

FIG. 2 shows examples of antenna elements that can be utilized in an antenna having one or more features as described herein.

FIG. 3 shows that in some embodiments, an antenna can be implemented in an adapter device.

FIG. 4A to FIG. 4C show non-limiting examples where two-element antennas can be implemented as parts of an adapter device such as the adapter device of FIG. 3.

FIG. 5 shows reflection coefficient plots for the first antenna example of FIG. 4A.

FIG. 6 shows top, front and back views of radiation pattern for the first antenna element of the antenna of FIG. 4A when the second antenna element is OFF.

FIG. 7 shows a gain plot for the first antenna element of the antenna of FIG. 4A when the second antenna element is OFF.

FIG. 8 shows top, front and back views of radiation pattern for the second antenna element of the antenna of FIG. 4A when the first antenna element is OFF.

FIG. 9 shows a gain plot for the second antenna element of the antenna of FIG. 4A when the first antenna element is OFF.

FIG. 10 shows top, front and back views of radiation pattern for the first antenna element of the antenna of FIG. 4B when the second antenna element is OFF.

FIG. 11 shows a gain plot for the first antenna element of the antenna of FIG. 4B when the second antenna element is OFF.

FIG. 12 shows top, front and back views of radiation pattern for the second antenna element of the antenna of FIG. 4B when the first antenna element is OFF.

FIG. 13 shows a gain plot for the second antenna element of the antenna of FIG. 4B when the first antenna element is OFF.

FIG. 14 shows top, front and back views of radiation pattern for the first antenna element of the antenna of FIG. 4C when the second antenna element is OFF.

FIG. 15 shows a gain plot for the first antenna element of the antenna of FIG. 4C when the second antenna element is OFF.

FIG. 16 shows top, front and back views of radiation pattern for the second antenna element of the antenna of FIG. 4C when the first antenna element is OFF.

FIG. 17 shows a gain plot for the second antenna element of the antenna of FIG. 4C when the first antenna element is OFF.

FIG. 18 shows that in some embodiments, an adapter such as a dongle can include an antenna having one or more features as described herein.

FIG. 19 shows that in some embodiments, the dongle of FIG. 18 can be configured to be connected to a wireless device through a cord, and such a connection can be configured to support transmit and/or receive operation(s) through the antenna of the dongle.

FIG. 20 shows that in some embodiments, the dongle of FIG. 18 can be configured to be plugged into a wireless device, and such a connection can be configured to support transmit and/or receive operation(s) through the antenna of the dongle.

FIG. 21 shows that in some embodiments, an antenna having one or more features as described herein can be included directly within a wireless device.

### DETAILED DESCRIPTION OF SOME EMBODIMENTS

The headings provided herein, if any, are for convenience only and do not necessarily affect the scope or meaning of the claimed invention.

In some implementations, the present disclosure relates generally to antennas for wireless applications such as internet of things (IoT) applications utilizing, for example, 2.54 GHz. However, it will be understood that one or more features of the present disclosure can also be utilized for other wireless applications and/or other frequency ranges.

Disclosed are examples of antennas having omnidirectional and high gain properties. In some embodiments, an antenna having such property can be implemented with one or more antenna elements patterned on a substrate. For the purpose of description, such patterned antenna element(s) can be formed by, for example, patterned printing of an appropriate conductive material, and the substrate can be, for example, a printed circuit board. It will be understood that one or more features of the present disclosure can also be implemented with other types of patterning techniques and/or other types of substrates.

In some embodiments, each of the foregoing one or more antenna elements can have an inverted-F shape or a shape based on such an inverted-F shape. Accordingly, an antenna having such antenna element(s) can be referred to as a printed inverted-F antenna.

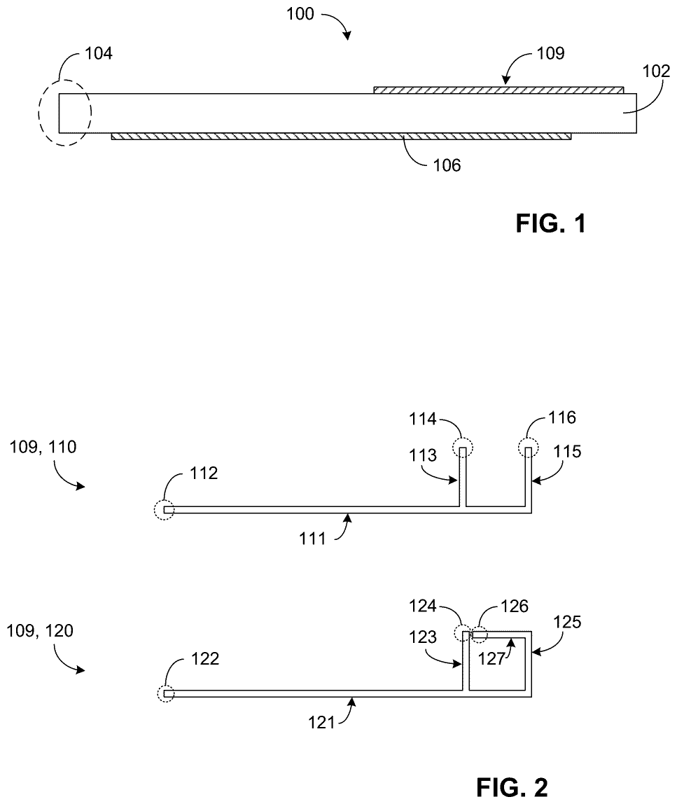

FIG. 1 shows a side view of an antenna 100 having one or more features as described herein. Such an antenna can include a substrate 102 such as a printed circuit board having first and second sides. On one side (e.g., on the upper side as shown in FIG. 1), an assembly of one or more antenna elements, collectively indicated as 109, can be formed; and on the other side, a ground plane 106 can be provided. Such a ground plane can be coupled to a portion of each of the one or more antenna elements as described herein.

FIG. 1 further shows that in some embodiments, a connection circuit 104 can be provided. Such a connection circuit can be configured to couple the antenna element(s) 109 to a wireless circuit.

FIG. 2 shows examples of antenna elements that can be utilized in an antenna having one or more features as described herein. In some embodiments, each of such antenna elements can be utilized as an antenna element 109 of the antenna 100 of FIG. 1.

FIG. 2 shows that in some embodiments, an antenna element can include an “F” shaped element 110. In such an example, the F-shaped element 110 can include a segment 111 having a first end 112 and a second end from which a first extension 115 extends therefrom to an end 116. A second extension 113 is shown to extend from a location along the segment 111 to an end 114, thereby forming an F-shape. In some embodiments, each of the first and second extensions 115, 113 can be oriented to be perpendicular or approximately perpendicular to the segment 111.

In some embodiments, the end 114 of the second extension 113 can be utilized as a feed point, and the end 116 of the first extension 115 can be utilized as a grounding point. Accordingly, and assuming that the first end 112 of the segment 111 is un-connected, the F-shaped element 110 can be dimensioned to support, for example, quarter-wave of a signal being transmitted and/or received.

FIG. 2 also shows that in some embodiments, an antenna element can include a modified “F” shaped element 120. In such an example, the modified F-shaped element 120 can include a segment 121 having a first end 122 and a second end from which a first extension 125 extends therefrom, followed by another extension 127 to an end 126. A second extension 123 is shown to extend from a location along the segment 121 to an end 124, thereby forming a modified F-shape having a shape similar to a letter “P.” Thus, for the purpose of description, the modified F-shaped element 120 may be referred to herein as a P-shaped element 120. In some embodiments, each of the first and second extensions 125, 123 can be oriented to be perpendicular or approximately perpendicular to the segment 121, and the extension 127 can be perpendicular or approximately perpendicular to the first extension 125.

In some embodiments, the end 124 from the second extension 123 can be utilized as a feed point, and the end 126 from the first extension 125 can be utilized as a grounding point. Accordingly, and assuming that the first end 122 of the segment is un-connected, the P-shaped element 120 can be dimensioned to support, for example, quarter-wave of a signal being transmitted and/or received.

In some embodiments, an antenna as described herein can include two antenna elements selected from the antenna elements 110, 120. Examples of such two-element antennas are described herein in greater detail.

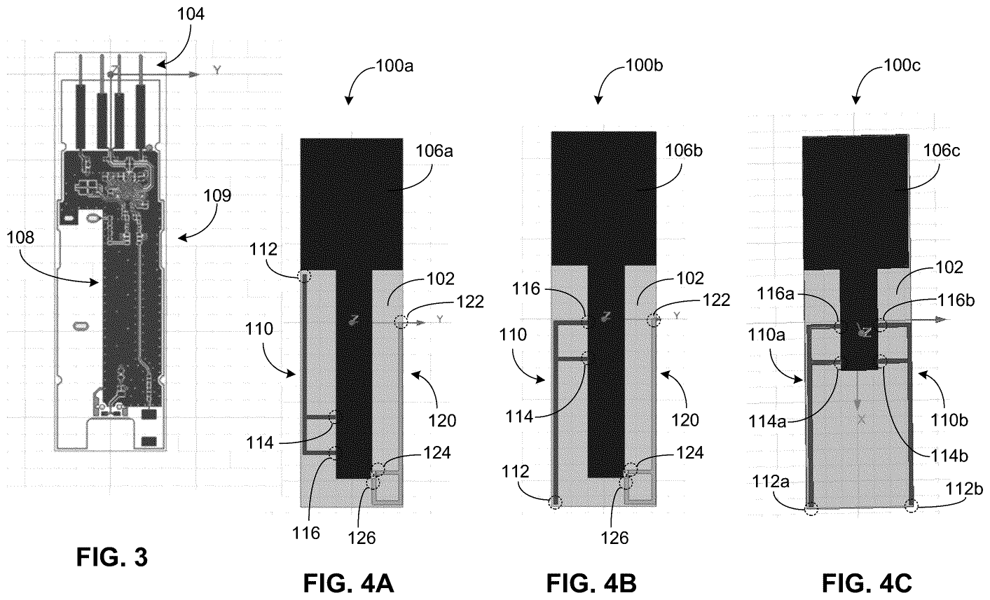

FIG. 3 shows that in some embodiments, an antenna having one or more features as described herein can be implemented in an adapter device 109. Such an adapter device can include an adapter circuit 108 and a connector assembly 104 to thereby provide desired adapter functionalities for an electronic device such as a wireless device. In some embodiments, the adapter circuit 108 can be implemented on a circuit board that also supports the antenna. Examples of such a circuit board are described herein in greater detail.

FIG. 4A to 4C show non-limiting examples where two-element antennas can be implemented as parts of an adapter device such as the adapter device of FIG. 3.

In a first example of FIG. 4A, a circuit board 102 is shown to be dimensioned to generally fit inside the adapter device of FIG. 3, and such a circuit board can be configured to support the adapter circuit 108.

Referring to FIGS. 1 to 3 and 4A, an antenna 100a can include a ground plane 106a formed on one side of the circuit board 102, and two antenna elements 110, 120 formed on the other side of the circuit board 102. In the example of FIG. 4A, the first antenna element 110 is an F-shaped element arranged so that the end 112 is positioned at a lateral location at or near a base portion of the ground plane 106a and at or near the respective edge of the circuit board 102. The grounding end 116 is shown to be at a lateral location near an end of a narrower extension of the ground plane 106a, and the feed end 114 is shown to be at a lateral location between the grounding end 116 and the base of the ground plane 106a.

In the example of FIG. 4A, the second antenna element 120 is a P-shaped element arranged so that the end 122 is positioned at a location towards the base portion of the ground plane 106a and at or near the respective edge of the circuit board 102. The grounding end 126 is shown to be at a location at the end of the narrower extension of the ground plane 106a, and the feed end 124 is shown to be at a location near the grounding end 126.

Configured in the foregoing manner, the antenna 100a of FIG. 4A can have nulls at approximately 90, −90 degrees, and a maximum gain at approximately 0 degree for the first antenna element 110 and a maximum gain at approximately 180 degrees for the second antenna element 120.

Referring to FIGS. 1 to 3 and 4B, an antenna 100b can include a ground plane 106b formed on one side of the circuit board 102, and two antenna elements 110, 120 formed on the other side of the circuit board 102. In the example of FIG. 4B, the first antenna element 110 is an F-shaped element arranged so that the end 112 is positioned at a lateral location at or near the end of the circuit board 102 away from a base portion of the ground plane 106b and at or near the respective edge of the circuit board 102. The grounding end 116 is shown to be at a lateral location along a narrower extension of the ground plane 106b, and the feed end 114 is shown to be at a lateral location along the narrower extension further away from the base of the ground plane 106b.

In the example of FIG. 4B, the second antenna element 120 is a P-shaped element arranged so that the end 122 is positioned at a lateral location towards the base portion of the ground plane 106a and at or near the respective edge of the circuit board 102. The grounding end 126 is shown to be at a lateral location at the end of the narrower extension of the ground plane 106a, and the feed end 124 is shown to be at a lateral location near the grounding end 126.

Configured in the foregoing manner, the antenna 100b of FIG. 4B can provide a response where one antenna element has nulls at approximately −30, −150 degrees, and the other antenna element has nulls at approximately 0, −180 degrees.

Referring to FIGS. 1 to 3 and 4C, an antenna 100c can include a ground plane 106c formed on one side of the circuit board 102, and two antenna elements 110a, 110b formed on the other side of the circuit board 102. In the example of FIG. 4C, the first antenna element 110a is an F-shaped element arranged so that the end 112a is positioned at a lateral location at or near the end of the circuit board 102 away from a base portion of the ground plane 106c and at or near the respective edge of the circuit board 102. The grounding end 116a is shown to be at a lateral location along a narrower extension of the ground plane 106c, and the feed end 114a is shown to be at a lateral location at or near the end of the narrower extension of the ground plane 106c. It is noted that the narrower extension of the ground plane 106c is shorter than the narrower extension of the ground plane 106b of FIG. 4B.

In the example of FIG. 4C, the second antenna element 110b is another F-shaped element arranged so as to be generally a mirror image of the first antenna element 110a with respect to a midline of the ground plane 106c. More particularly, the second antenna element 110b is an F-shaped element arranged so that the end 112b is positioned at a lateral location at or near the end of the circuit board 102 away from the base portion of the ground plane 106c and at or near the respective edge of the circuit board 102. The grounding end 116b is shown to be at a lateral location along the narrower extension of the ground plane 106c, and the feed end 114b is shown to be at a lateral location at or near the end of the narrower extension of the ground plane 106c.

Configured in the foregoing manner, the antenna 100c of FIG. 4C can provide a response where one antenna element has nulls at approximately −30, 150 degrees, and the other antenna element has nulls at approximately −150, 30 degrees.

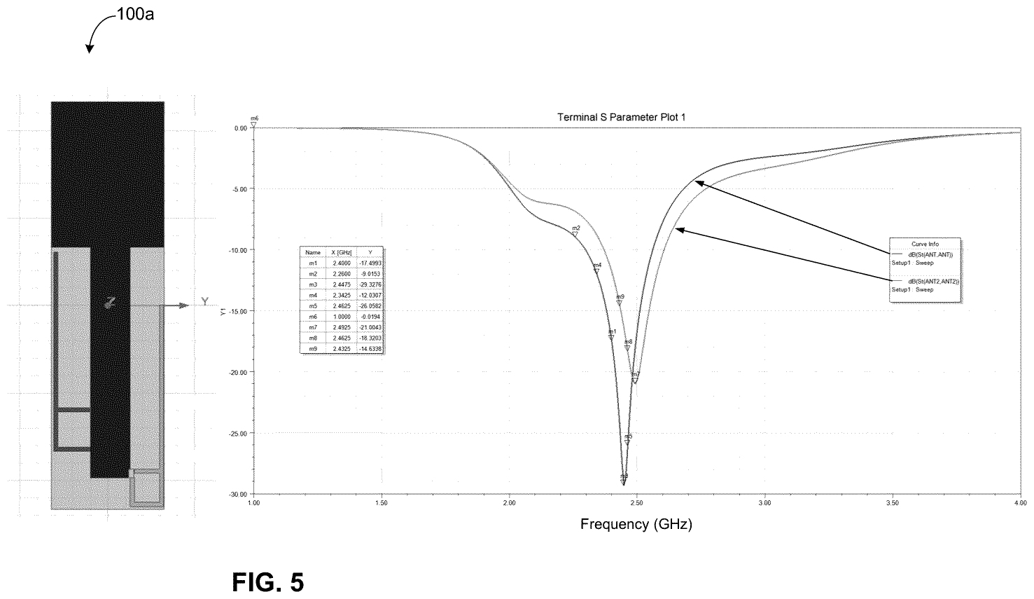

FIGS. 5 to 9 show various antenna performance plots for the first antenna example 100a of FIG. 4A.

For example, FIG. 5 shows reflection coefficient plots for the first antenna example 100a of FIG. 4A. More particularly, the first antenna element (110 in FIG. 4A) is shown to provide a reflection coefficient response with a minimum data point m3 having values of 2.45 GHz and −29.3 dB. The second antenna element (120 in FIG. 4A) is shown to provide a reflection coefficient response with a minimum data point m7 having values of 2.49 GHz and −21.0 dB.

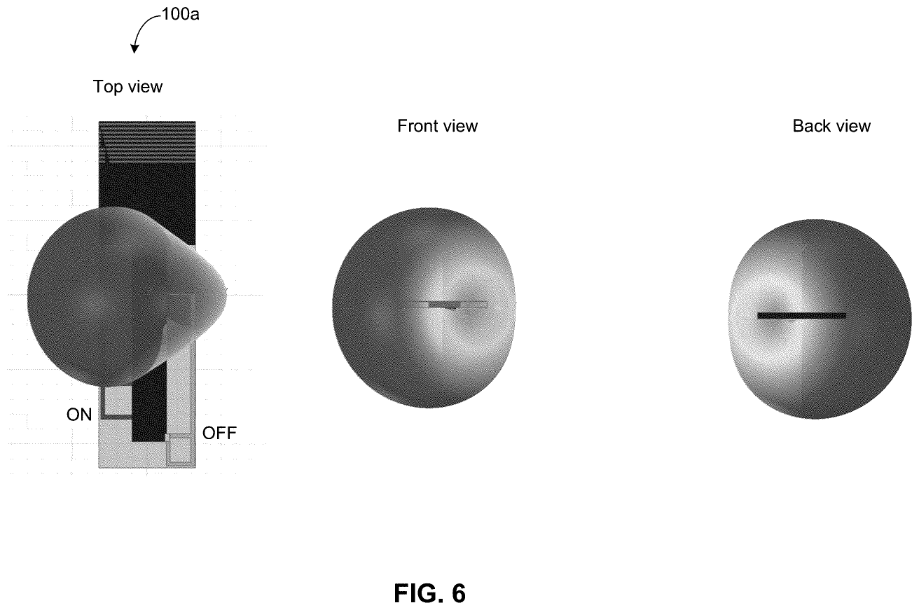

In another example, FIG. 6 shows top, front and back views of radiation pattern for the first antenna element 110 of the antenna 100a of FIG. 4A when the second antenna element 120 is OFF. Such a pattern is shown to include nulls at approximately 0, −180 degrees, and a maximum gain at approximately 90 degrees for the first antenna element 110 and at approximately −90 degrees for the second antenna element 120.

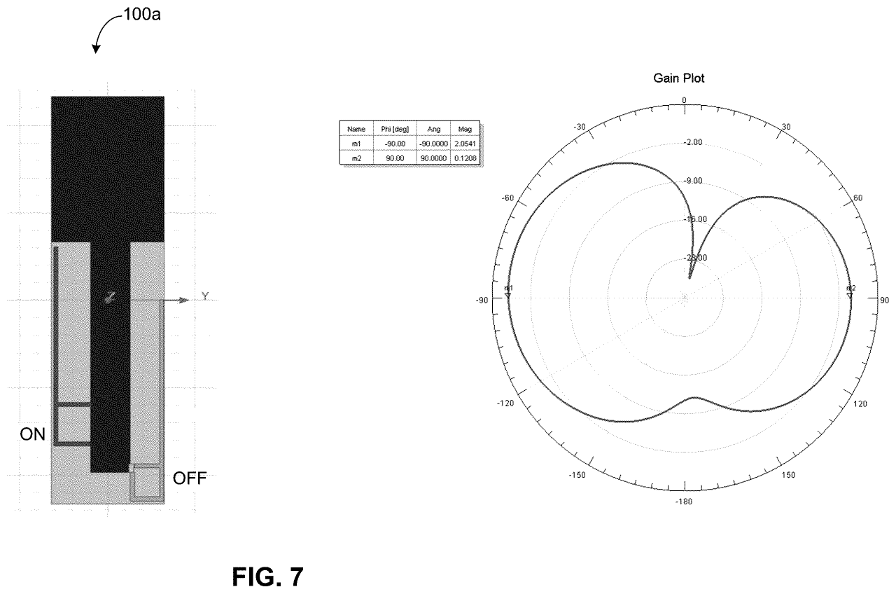

In yet another example, FIG. 7 shows a gain plot for the first antenna element 110 of the antenna 100a of FIG. 4A when the second antenna element 120 is OFF. Such a plot is shown to include nulls at approximately 0, −180 degrees, and a maximum gain at approximately −90 degrees for the first antenna element 110 and at approximately 90 degrees for the second antenna element 120.

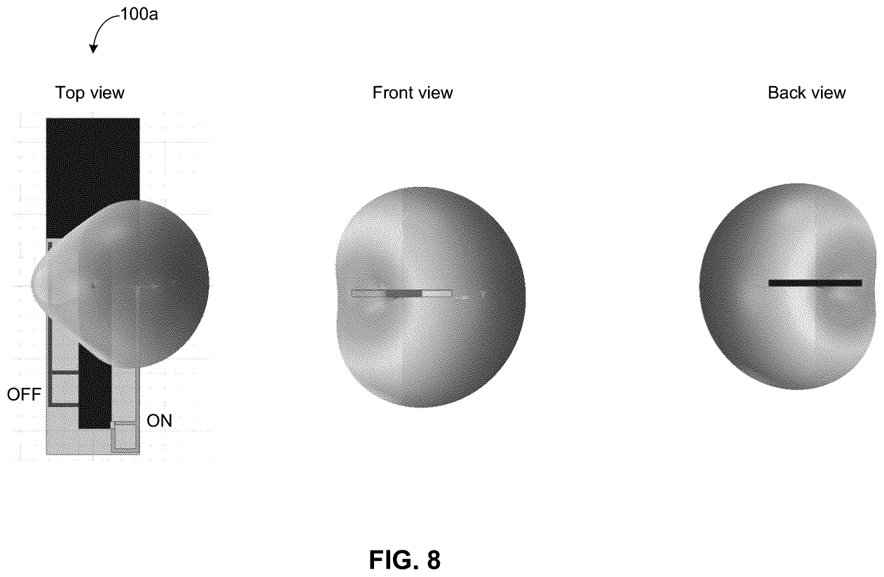

In yet another example, FIG. 8 shows top, front and back views of radiation pattern for the second antenna element 120 of the antenna 100a of FIG. 4A when the first antenna element 110 is OFF. Such a pattern is shown to include nulls at approximately 0, −180 degrees, and a maximum gain at approximately −90 degrees for the first antenna element 110 and at approximately 90 degrees for the second antenna element 120.

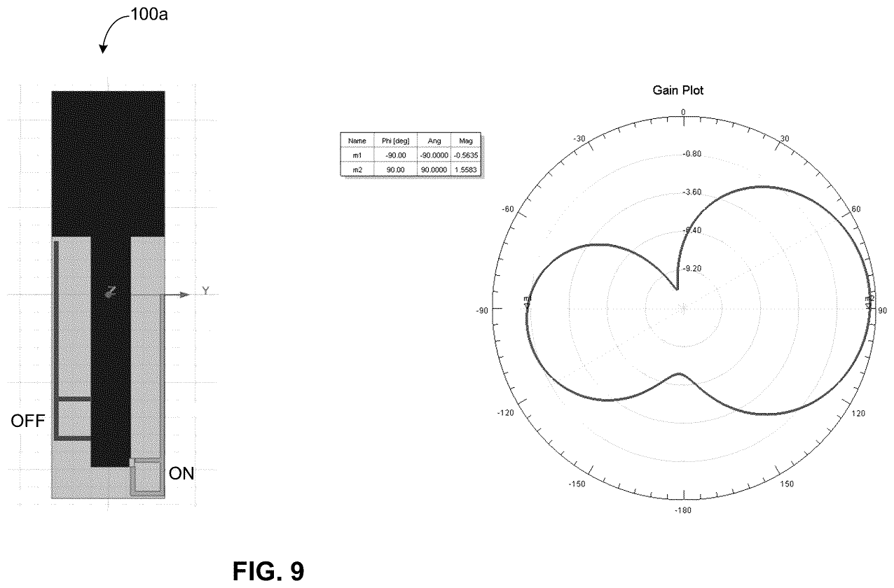

In yet another example, FIG. 9 shows a gain plot for the second antenna element 120 of the antenna 100a of FIG. 4A when the first antenna element 110 is OFF. Such a plot is shown to include nulls at approximately 0, −180 degrees, and a maximum gain at approximately 90 degrees for the first antenna element 110 and at approximately −90 degrees for the second antenna element 120.

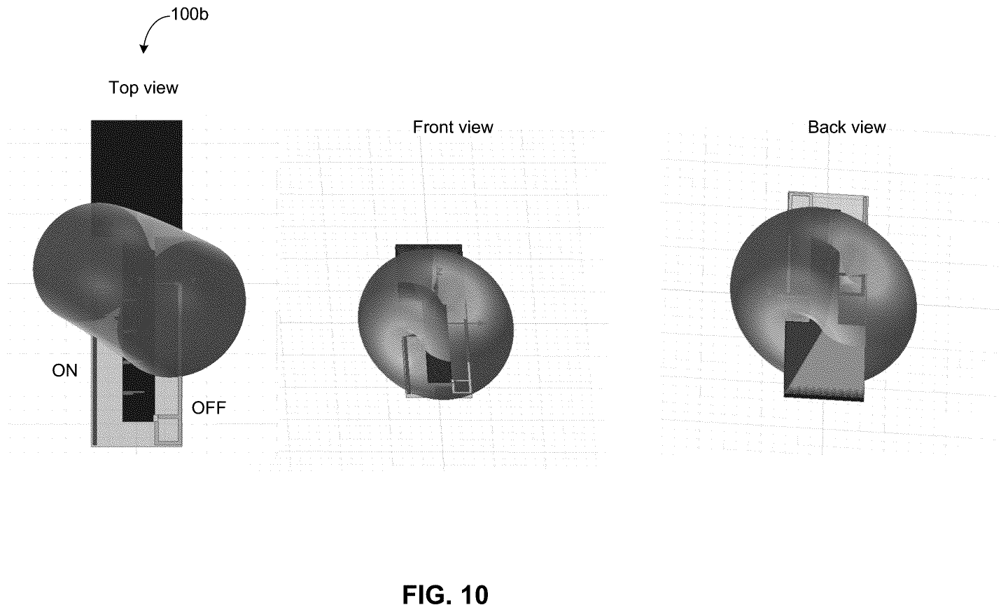

FIG. 10 shows top, front and back views of radiation pattern for the first antenna element 110 of the antenna 100b of FIG. 4B when the second antenna element 120 is OFF. Such a pattern is shown to include nulls at approximately −30, −150 degrees, and a maximum gain at approximately 60 degrees for the first antenna element 110 and at approximately 90 degrees for the second antenna element 120.

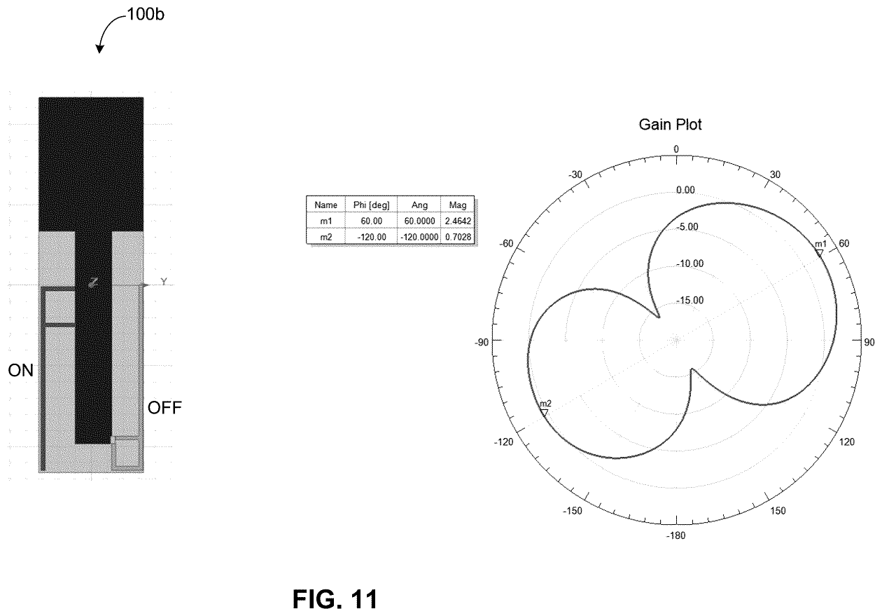

FIG. 11 shows a gain plot for the first antenna element 110 of the antenna 100b of FIG. 4B when the second antenna element 120 is OFF. Such a plot is shown to include nulls at approximately −30, −150 degrees, and a maximum gain at approximately 60 degrees for the first antenna element 110 and at approximately 60 degrees for the second antenna element 120.

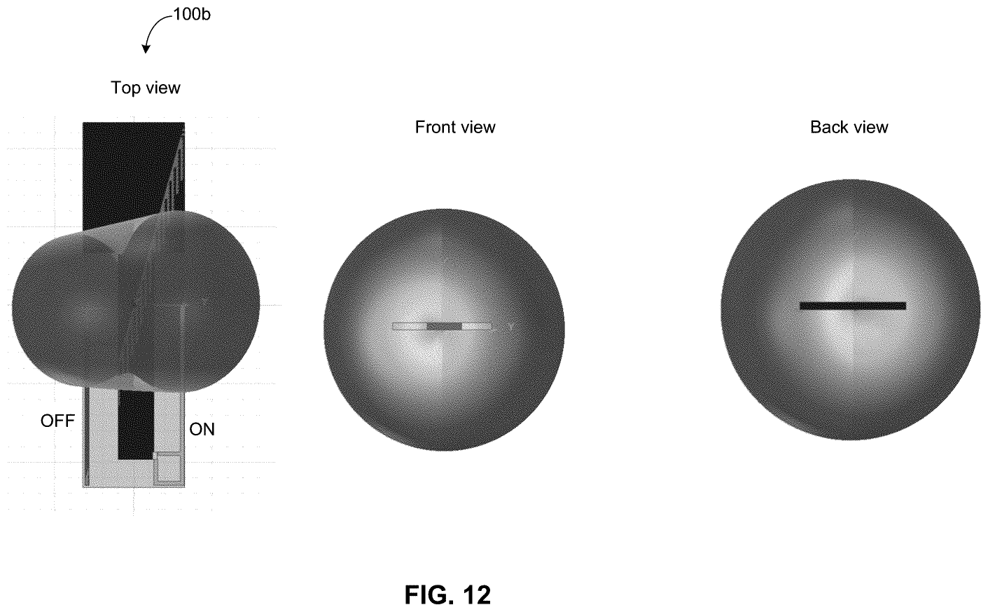

FIG. 12 shows top, front and back views of radiation pattern for the second antenna element 120 of the antenna 100b of FIG. 4B when the first antenna element 110 is OFF. Such a pattern is shown to include nulls at approximately 0, −180 degrees, and a maximum gain at approximately 90 degrees for the first antenna element 110 and at approximately 90 degrees for the second antenna element 120.

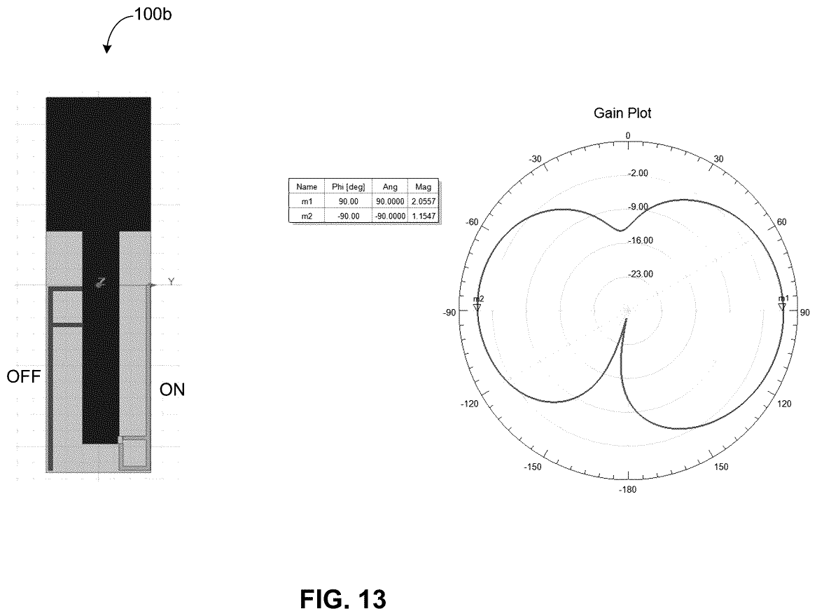

FIG. 13 shows a gain plot for the second antenna element 120 of the antenna 100b of FIG. 4B when the first antenna element 110 is OFF. Such a plot is shown to include nulls at approximately 0, −180 degrees, and a maximum gain at approximately 90 degrees for the first antenna element 110 and at approximately 90 degrees for the second antenna element 120.

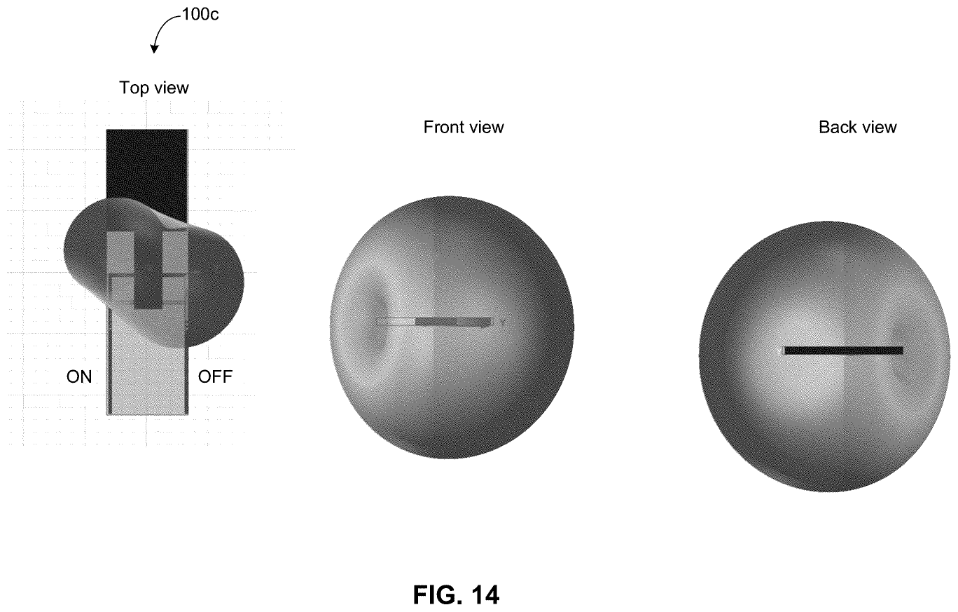

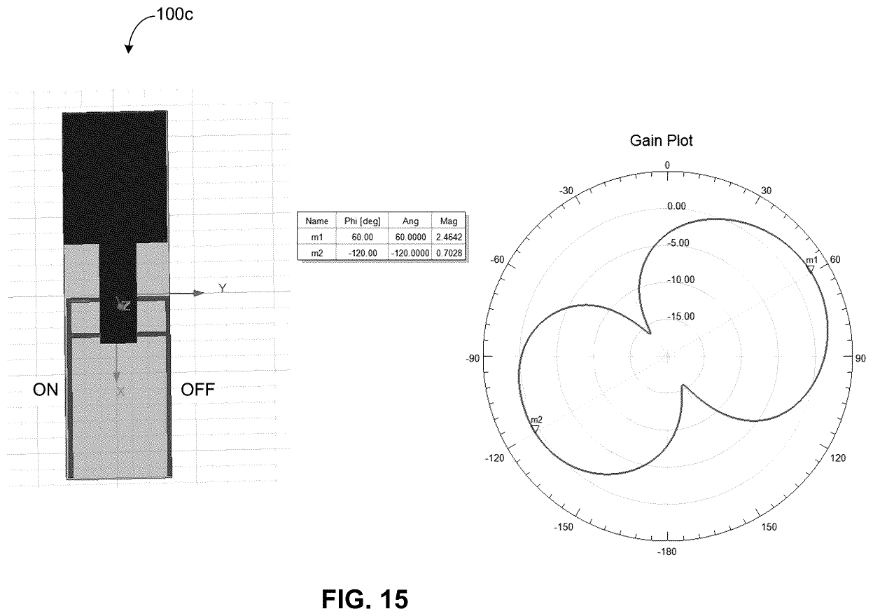

FIG. 14 shows top, front and back views of radiation pattern for the first antenna element 110a of the antenna 100c of FIG. 4C when the second antenna element 110b is OFF. FIG. 15 shows a gain plot for the first antenna element 110a of the antenna 100c of FIG. 4C when the second antenna element 110b is OFF. Such a plot is shown to include nulls at approximately −30, 150 degrees, and a maximum gain at approximately 60 degrees for the first antenna element 110a and at approximately-30 degrees for the second antenna element 110b.

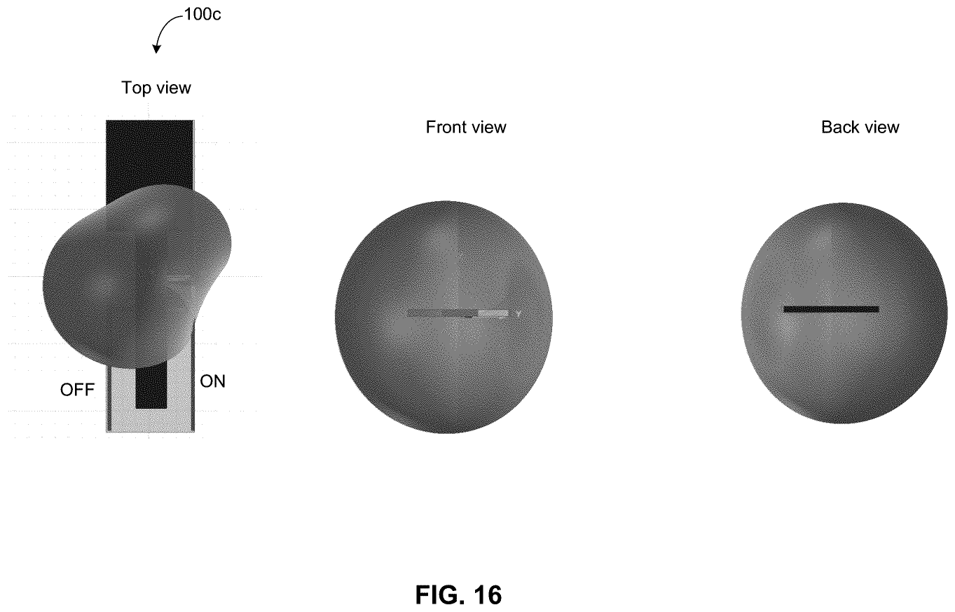

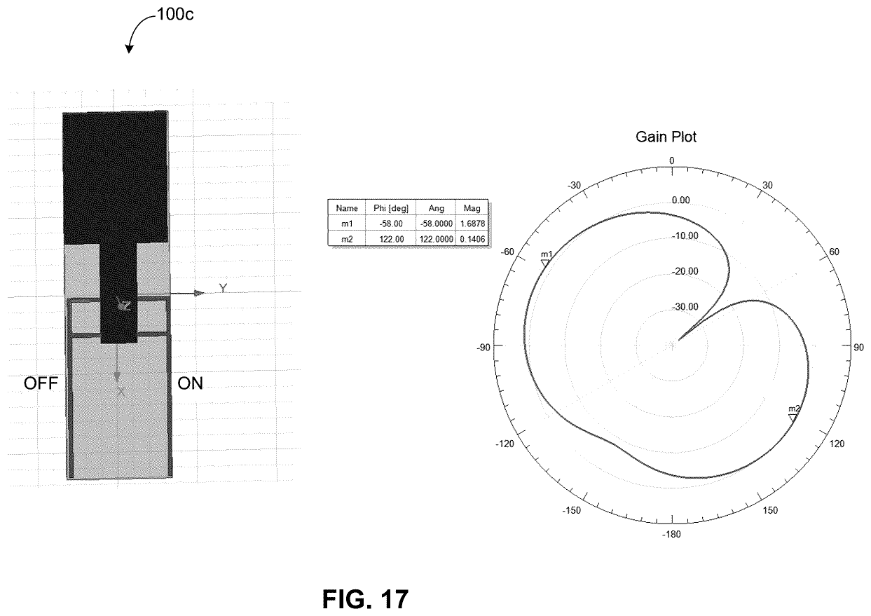

FIG. 16 shows top, front and back views of radiation pattern for the second antenna element 110b of the antenna 100c of FIG. 4C when the first antenna element 110a is OFF. FIG. 17 shows a gain plot for the second antenna element 110b of the antenna 100c of FIG. 4C when the first antenna element 110a is OFF. Such a plot is shown to include nulls at approximately 30, −150 degrees, and a maximum gain at approximately −30 degrees for the first antenna element 110a and at approximately 60 degrees for the second antenna element 110b.

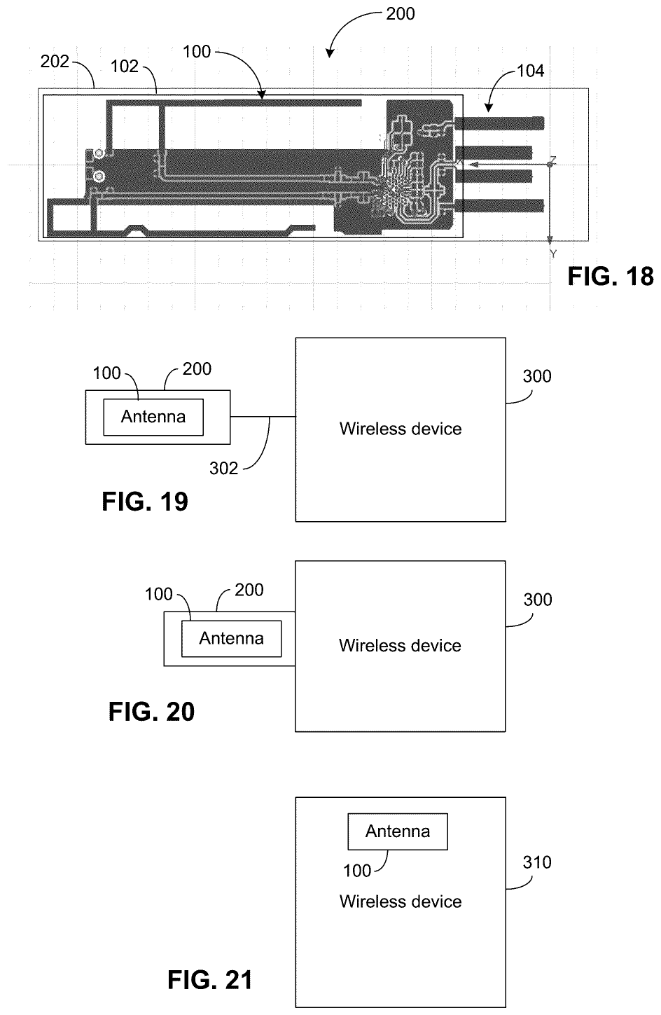

FIG. 18 shows that in some embodiments, an adapter such as a dongle 200 can include an antenna 100 having one or more features as described herein. In some embodiments, such a dongle can include a housing 202 and a circuit board 102 that supports the antenna 100 and related circuit. The dongle 200 can also include an assembly of connection features 104 configured to allow coupling of the dongle 200 and the antenna 100 therein with another device such as a wireless device.

FIG. 19 shows that in some embodiments, the dongle 200 of FIG. 18 can be configured to be connected to a wireless device 300 through a cord 302, and such a connection can be configured to support transmit and/or receive operation(s) through the antenna 100 of the dongle 200.

FIG. 20 shows that in some embodiments, the dongle 200 of FIG. 18 can be configured to be plugged into a wireless device 300, and such a connection can be configured to support transmit and/or receive operation(s) through the antenna 100 of the dongle 200.

FIG. 21 shows that in some embodiments, an antenna 100 having one or more features as described herein can be included directly within a wireless device 310.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. An antenna comprising:
a substrate;
a ground plane; and
first and second antenna elements each having a shape selected from an F-shape and a P-shape, each antenna element including a feed point connectable to an antenna circuit and a grounding point electrically connected to the ground plane.

2. The antenna of claim 1 wherein each of the F-shape and the P-shape includes a segment having a base end when the respective shape is oriented upright.

3. The antenna of claim 2 wherein the first antenna element has the F-shape and the second antenna element has the P-shape.

4. The antenna of claim 2 wherein the first antenna element has the F-shape and the second antenna element has the F-shape.

5. The antenna of claim 2 wherein the first antenna element has the P-shape and the second antenna element has the P-shape.

6. The antenna of claim 2 wherein the ground plane has a base portion having a first width, and an extension portion having a second width smaller than the first width.

7. The antenna of claim 6 wherein the base end of each antenna element is positioned towards the base portion of the ground plane.

8. The antenna of claim 6 wherein the base end of each antenna element is positioned away from the base portion of the ground plane.

9. The antenna of claim 6 wherein the base end of one antenna element is positioned towards the base portion of the ground plane, and the base end of the other antenna element is positioned away from the base portion of the ground plane.

10. The antenna of claim 1 wherein the substrate includes a circuit board.

11. The antenna of claim 10 wherein the ground plane is implemented on one side of the circuit board and the first and second antenna elements are implemented on the other side of the circuit board.

12. The antenna of claim 11 wherein the circuit board is dimensioned to fit within an adapter device.

13. The antenna of claim 12 wherein the adapter device is implemented as a dongle device.

14. The antenna of claim 10 wherein each of the first and second antenna elements includes a patterned conductor.

15. The antenna of claim 14 wherein the patterned conductor includes a printed pattern formed from a conductive material.

16. A dongle comprising:
a housing;
a circuit board dimensioned to fit within the housing; and
an antenna assembly implemented relative to the circuit board, the antenna assembly including a ground plane, and first and second antenna elements each having a shape selected from an F-shape and a P-shape, each antenna element including a feed point connectable to an antenna circuit and a grounding point electrically connected to the ground plane.

17. The dongle of claim 16 wherein each of the F-shape and the P-shape includes a segment having a base end when the respective shape is oriented upright.

18. (canceled)

19. (canceled)

20. (canceled)

21. The dongle of claim 17 wherein the ground plane has a base portion having a first width, and an extension portion having a second width smaller than the first width.

22. The dongle of claim 21 wherein the base end of each antenna element is positioned towards the base portion of the ground plane.

23. (canceled)

24. (canceled)

25. A wireless comprising:
a radio-frequency circuit; and
an antenna coupled to the radio-frequency circuit and configured to support a transmit operation and/or a receive operation, the antenna implemented on a substrate and including a ground plane and first and second antenna elements each having a shape selected from an F-shape and a P-shape, each antenna element including a feed point selectively connectable to the radio-frequency circuit and a grounding point electrically connected to the ground plane.
